(19) United States
(12) Patent Application Publication
(10) Pub. No.: US 2013/0055243 A1
(43) Pub. Date: Feb. 28, 2013

(54) Unified Management Architecture to Support Multiple Platform-as-a-Service Workloads

(71) Applicants: Shree Dandekar, Round Rock, TX (US); James Craig Lowery, Austin, TX (US)

(72) Inventors: Shree Dandekar, Round Rock, TX (US); James Craig Lowery, Austin, TX (US)

(73) Assignee: DELL PRODUCTS, LP, Round Rock, TX (US)

(21) Appl. No.: 13/216,643

(22) Filed: Aug. 24, 2011

(51) Int. Cl. G06F 9/455

(52) U.S. Cl. 718/1

(57) ABSTRACT

An information handling system includes a memory and a workload manager. The memory stores a first application associated with a first platform of a plurality of platforms, and a second application associated with a second platform of the plurality of platforms. The workload manager is configured to receive rights and policies for the first application, and rights and policies for the second application; to include the rights and policies for the first application as metadata in the first application, and the rights and policies for the second application as metadata in the second application; to receive a selection of the first application, to determine whether features for the first application are currently running; if the features for the first application are not currently running, create a first virtual machine having the first platform, and the rights and policies for the first application; and to provide an instance of the first application on the first virtual machine.

### FIELD OF THE DISCLOSURE

This disclosure generally relates to information handling systems, and more particularly relates to a unified management architecture to support multiple platform as a service workloads.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

Cloud computing can be used to deliver different services, such as Infrastructure-as-a-Service (IaaS), Software-as-a-Service (SaaS), and Platform-as-a-Service (PaaS). IaaS can be leveraged by virtualizing an existing physical server into different virtual machines. SaaS can provide a user using a thin client with software and data stored at a remote location. PaaS can deliver a computing platform and related software to provide a user with a functional product or service. PaaS can integrate IaaS and SaaS to provide a specific platform for executing different applications associated with that platform.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a unified platform management system;

FIG. 2 is a block diagram of a virtual integrated system implementing the unified platform management system;

FIG. 3 is a exemplary platform-as-a-service virtual machine of the virtual integrated system;

FIG. 4 is a flow diagram of a method for providing a platform-as-a-service virtual machine in the unified platform management system; and

FIG. 5 is a block diagram of a general information handling system.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application.

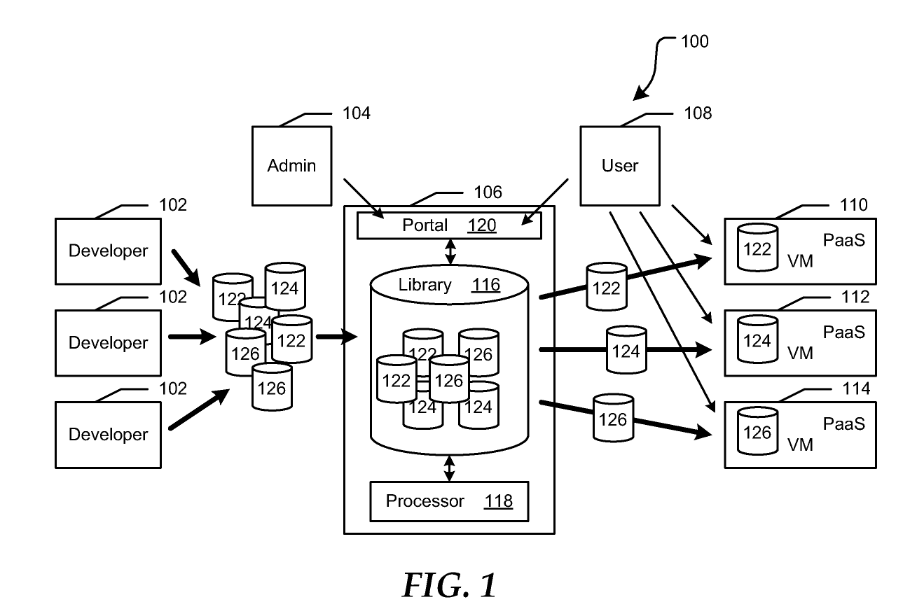

FIG. 1 shows a unified platform management system 100 of an information handling system. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

The unified platform management system 100 includes developers 102, an administrator 104, workload manager 106, a user 108, and platform-as-a-service (PaaS) virtual machines (VMs) 110, 112, and 114. In an embodiment, the workload manager 106 is located within a server. The workload manager 106 includes a library 116, a processor 118, and a portal 120. The developers 102 are in communication with library 116, which in turn is in communication with the administrator 104 and with the user 108 via the portal 120, with the PaaS VMs 110, 112, and 114, and with the processor 118. The workload manager 106 can be one or more servers having the processor 118, a memory or library 116, the portal 120, and additional resources to provide the administrator 104 and the user 108 with the ability to store, manage, and execute applications or workloads 122-126. The PaaS VMs 110-114 may be virtual machines partitioned on the server of workload manager 106 or on one or more additional servers.

Each of the developers 102 can create the applications or workloads 122, 124, and 126, which can each require a different platform to operate. For example, the applications 122 can be .Net-based applications that run in a Microsoft Windows environment and run in an Azure public cloud, applications 124 can be Java-based workloads running in a VMware application cloud, and applications 126 can be different Java developed applications that use JBoss integrated development environment (IDE).

The administrator 104 of the workload manager 106 can acquire the different applications 122-126 from the developers, and can import the selected application into the library 116 via the portal 120. The administrator 106 can then set up rights and policies for each of the applications 122-126. The rights and policies can include an authentication process for executing a particular instance of an application, allowable targets for the application, limitations on individuals that can be granted access to the applications 122-126, and the like. Allowable targets can be different devices that can execute the applications 122-126 based on whether security requirements allow applications to be run on a public cloud, constrained to a private cloud, or the like. The information about the rights and policies for each of the applications 122-126 can be attached as metadata to the specific application.

The user 108 can access the library 116 via the portal 120, and can view the different applications 122-126. The portal 120 can be a graphical user interface (GUI) to provide the user with the ability to select one of the applications 122-126. The user 108 may only have access to specific applications based on restrictions assigned to the application 122-126. The user 108 can then select an application to execute from the applications 122-126 via the portal 120. The processor 118 can detect the application selected by the user 108, and can determine the platform and resources needed to run the application.

For example, if the user 108 selects application 122, the processor 118 can use the metadata associated with the application to determine that the application needs specific features, such as the features of PaaS VM 110. The processor 118 of the workload manager 106 can then determine whether the PaaS VM 110 is already running, whether the features for PaaS VM 110 should be turned on, or the like. Thus, the processor 118 can either assign the application 122 to be run on the PaaS VM 110 that is already operational, or can create the PaaS VM by turning on necessary features. Similarly, if application 124 or 126 is selected, the processor 118 can assign the application to respective PaaS VM 112 or 114 that are already operational or can create the necessary PaaS VM needed for the application.

The user 108 can then utilize the selected application 122, 124, or 126 without necessarily knowing the PaaS VM 110, 112, or 114 with its specific platform that is running the application. Thus, the workload manager 106 can have access to all of the features, platforms, security, and functionality needed to execute any of the applications 122-126 without each of the applications needing to be designed for the same type of platform.

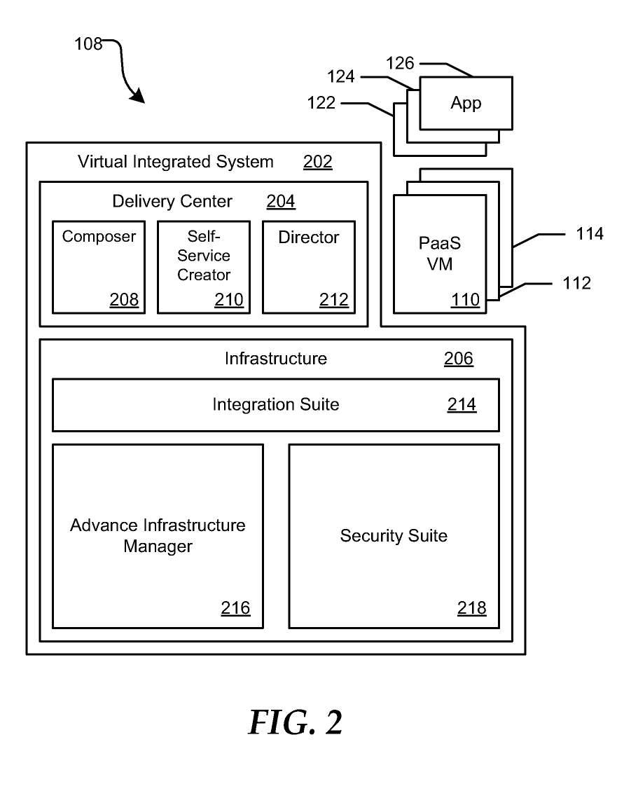

FIG. 2 shows a virtual integrated system (VIS) 202 associated with the workload manager 106. The VIS 202 includes a delivery center 204, an infrastructure 206, the PaaS VMs 110, 112, 114, and the applications 122, 124, and 126. The delivery center 204 includes a composer 208, a self-service creator 210, and a director 212. The infrastructure 206 includes an integration suite 214, an advanced infrastructure manager 216, and a security suite 218. The components of the delivery center 204 can communicate with the components of the infrastructure 206 via an application programming interface (API). The administrator 104 can utilize the composer 208 to receive and modify the applications 122-126 before storing the applications in the library 116. The self-service creator 210 can provide the portal 120 for communication between the administrator 104 and the library 116 to enable the administrator to manage and deploy the different applications 122-126 in the VIS system 202. The self-service creator 210 also can provide the portal 120 for communication between the user 108 and the library 116 to enable the user to select different applications 122-126 to run.

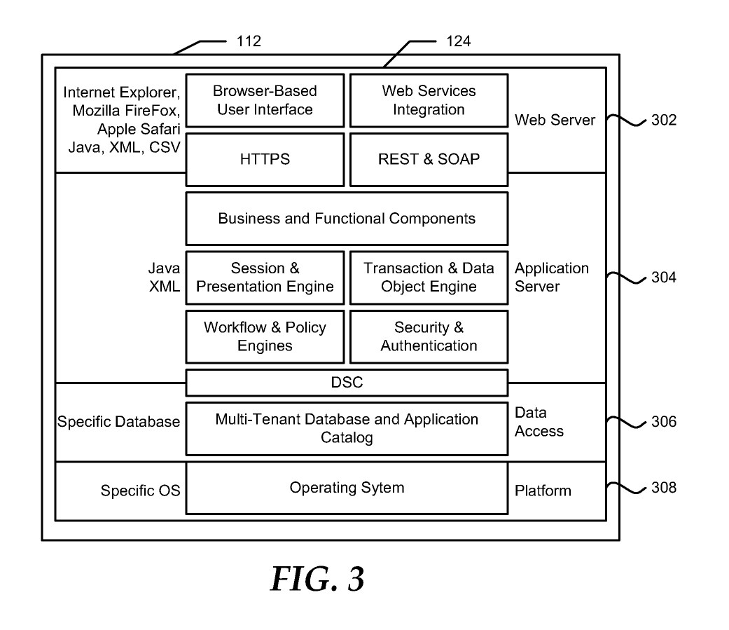

When the user 108 selects an application 122-126 via the portal 120, the director 212 can communicate with the integration suite 214, the advanced infrastructure manager 216, and the security suite 218, via the API of VIS 202, to access the infrastructure 206 and create one of the PaaS VMs 110-114 for the selected application. The director 212 of the delivery center 204 can determine the features associated with the selected application, such as application 124, and can communicate with the integration suite 214 and the advanced infrastructure manager 216 to enable the features on the PaaS VM 112. The features can be a web server 302, an application server 304, data access information 306, and a platform 308 associated with the application 124 as shown in FIG. 3.

FIG. 3 shows the PaaS VM 112 created in the virtual integrated system 202 for the application 124. The PaaS VM 112 includes the web server 302, the application server 304, data access information 306, and the platform 308 to run the application 124. For example, the integration suite 214 and the advanced infrastructure manager 216 can provide a browser-based user interface, web services integration, hypertext transfer protocol secure (HTTPS), representational state transfer (REST) protocol, and simple object access protocol (SOAP) to the PaaS VM 112 to enable the user 108 to communicate with and view the application 124. The web server 302, selected from the infrastructure 206 in the VIS 202 of FIG. 2, can also be Java based, extensible markup language (XML) based, comma-separated values (CSV) based, or the like and can operate on a browser such as Internet Explorer, Mozilla FireFox, or Apple Safari.

The integration suite 214, the advanced infrastructure manager 216, and the security suite 218 can provide the application server 304 for the application 112 as being either Java based or XML based. The application server 304 can provide business and functional components, a session and presentation engine, a transaction and data object engine, workflow and policy engines, and security and authentication. The integration suite 214 and the advanced infrastructure manager 216 can then access the infrastructure 206 to provide the data access 306 for the application 112, as a multi-tenant database, an application catalog, or another specific database. The integration suite 214 and the advanced infrastructure manager 216 can also select the platform 308 for the application as a specific operating system, such as windows or Linux. The security suite 218 can then determine whether the PaaS VM 112 can be provided in a public cloud or in a private cloud based on security features of the application 124. The PaaS VM 112 can then be enabled with all of the features for the application 124 so that an instance of the application can be executed by the user 108 on the PaaS VM.

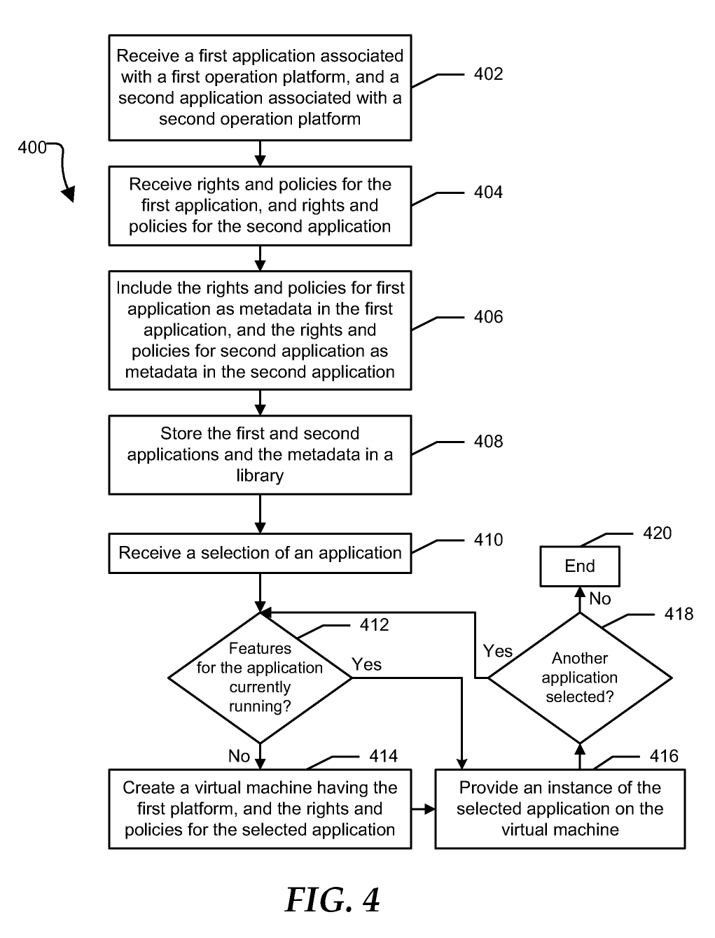

FIG. 4 shows a flow diagram of a method 400 for providing multiple platforms for application in a unified management system. At block 402, a first application associated with a first operation platform and a second application associated with a second operation platform are received. Rights and policies for the first application and rights and policies for the second application are received at block 404. The rights and policies can include an approval process for a purchase of a particular instance of an application, what can be allowable targets, and the like. Allowable targets can be based on whether an application can be run on a public cloud, constrained to a private cloud, or the like.

At block 406, the rights and policies for the first application are included as metadata in the first application, and the rights and policies for the second application are included as metadata in the second application. A selection of an application is received at block 410. At block 412, a determination is made whether features for the selected application are currently running. The features can include a web server, an application server, data access, and platform. If the features for the first application are currently running, the flow continues below at block 416. However, if the features for the selected application are not currently running, a virtual machine having the first platform, and the rights and policies for the selected application is created at block 414. At block 416, an instance of the selected application is provided on the virtual machine. If at new application is selected at block 418, the flow continues as stated above at block 412, otherwise the flow ends at block 420.

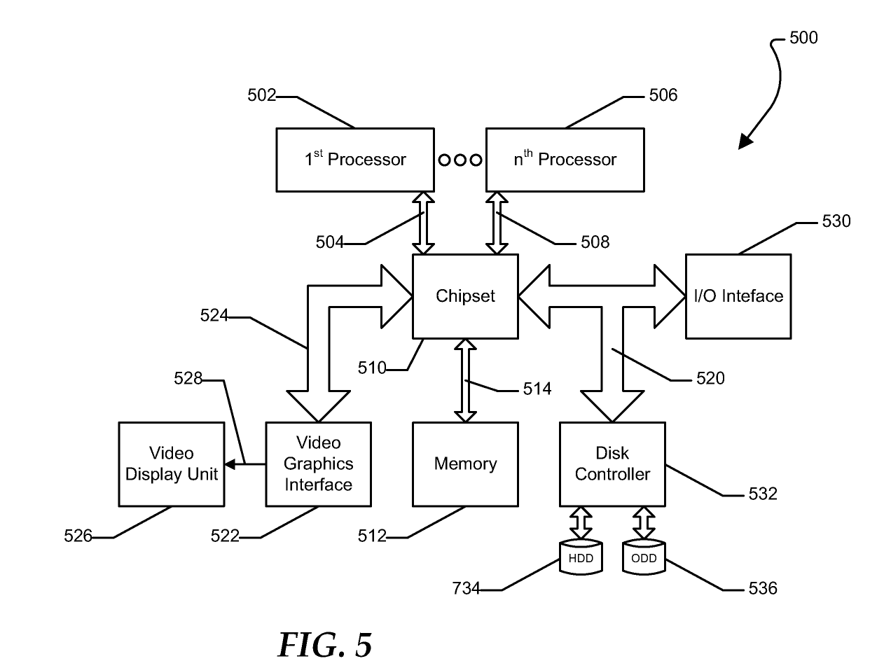

FIG. 5 illustrates a block diagram of a general information handling system, generally designated at 500. In one form, the information handling system 500 can be a computer system such as a server. As shown in FIG. 5, the information handling system 500 can include a first physical processor 502 coupled to a first host bus 504 and can further include additional processors generally designated as n^{th} physical processor 506 coupled to a second host bus 508. The first physical processor 502 can be coupled to a chipset 510 via the first host bus 504. Further, the n^{th} physical processor 506 can be coupled to the chipset 510 via the second host bus 508. The chipset 510 can support multiple processors and can allow for simultaneous processing of multiple processors and support the exchange of information within information handling system 500 during multiple processing operations.

According to one aspect, the chipset 510 can be referred to as a memory hub or a memory controller. For example, the chipset 510 can include an Accelerated Hub Architecture (AHA) that uses a dedicated bus to transfer data between first physical processor 502 and the n^{th} physical processor 506. For example, the chipset 510, including an AHA enabled-chipset, can include a memory controller hub and an input/output (I/O) controller hub. As a memory controller hub, the chipset 510 can function to provide access to first physical processor 502 using first bus 504 and n^{th} physical processor 506 using the second host bus 508. The chipset 510 can also provide a memory interface for accessing memory 512 using a memory bus 514. In a particular embodiment, the buses 504, 508, and 514 can be individual buses or part of the same bus. The chipset 510 can also provide bus control and can handle transfers between the buses 504, 508, and 514.

According to another aspect, the chipset 510 can be generally considered an application specific chipset that provides connectivity to various buses, and integrates other system functions. For example, the chipset 510 can be provided using an Intel® Hub Architecture (IHA) chipset that can also include two parts, a Graphics and AGP Memory Controller Hub (GMCH) and an I/O Controller Hub (ICH). For example, an Intel 820E, an 815E chipset, or any combination thereof, available from the Intel Corporation of Santa Clara, Calif., can provide at least a portion of the chipset 510. The chipset 510 can also be packaged as an application specific integrated circuit (ASIC).

The information handling system 500 can also include a video graphics interface 522 that can be coupled to the chipset 510 using a third host bus 524. In one form, the video graphics interface 522 can be an Accelerated Graphics Port (AGP) interface to display content within a video display unit 526. Other graphics interfaces may also be used. The video graphics interface 522 can provide a video display output 528 to the video display unit 526. The video display unit 526 can include one or more types of video displays such as a flat panel display (FPD) or other type of display device.

The information handling system 500 can also include an I/O interface 530 that can be connected via an I/O bus 520 to the chipset 510. The I/O interface 530 and I/O bus 520 can include industry standard buses or proprietary buses and respective interfaces or controllers. For example, the I/O bus 520 can also include a Peripheral Component Interconnect (PCI) bus or a high speed PCI-Express bus. In one embodiment, a PCI bus can be operated at approximately 56 MHz and a PCI-Express bus can be operated at approximately 528 MHz. PCI buses and PCI-Express buses can be provided to comply with industry standards for connecting and communicating between various PCI-enabled hardware devices. Other buses can also be provided in association with, or independent of, the I/O bus 520 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 510 can be a chipset employing a Northbridge/Southbridge chipset configuration (not illustrated). For example, a Northbridge portion of the chipset 510 can communicate with the first physical processor 502 and can control interaction with the memory 512, the I/O bus 520 that can be operable as a PCI bus, and activities for the video graphics interface 522. The Northbridge portion can also communicate with the first physical processor 502 using first bus 504 and the second bus 508 coupled to the n^{th} physical processor 506. The chipset 510 can also include a Southbridge portion (not illustrated) of the chipset 510 and can handle I/O functions of the chipset 510. The Southbridge portion can manage the basic forms of I/O such as Universal Serial Bus (USB), serial I/O, audio outputs, Integrated Drive Electronics (IDE), and ISA I/O for the information handling system 500.

The information handling system 500 can further include a disk controller 532 coupled to the I/O bus 520, and connecting one or more internal disk drives such as a hard disk drive (HDD) 534 and an optical disk drive (ODD) 536 such as a Read/Write Compact Disk (R/W CD), a Read/Write Digital Video Disk (R/W DVD), a Read/Write mini-Digital Video Disk (R/W mini-DVD), or other type of optical disk drive.

Although only a few exemplary embodiments have been described in detail above, those skilled in the art will readily appreciate that many modifications are possible in the exemplary embodiments without materially departing from the novel teachings and advantages of the embodiments of the present disclosure. For example, the methods described in the present disclosure can be stored as instructions in a computer readable medium to cause a processor, such as chipset 510, to perform the method. Additionally, the methods described in the present disclosure can be stored as instructions in a non-transitory computer readable medium, such as a hard disk drive, a solid state drive, a flash memory, and the like. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a first application associated with a first platform of a plurality of platforms, and a second application associated with a second platform of the plurality of platforms; and
a workload manager configured to receive rights and policies for the first application, and rights and policies for the second application; to include the rights and policies for the first application as metadata in the first application, and the rights and policies for the second application as metadata in the second application; to receive a selection of the first application, to determine whether features for the first application are currently running; if the features for the first application are not currently running, create a first virtual machine having the first platform, and the rights and policies for the first application; and to provide an instance of the first application on the first virtual machine.

2. The information handling system of claim 1 further comprising:
a server in communication with the workload manager, the server including the first virtual machine and the second virtual machine.

3. The information handling system of claim 1 wherein the workload manager is further configured to receive a selection of a second application; to determine whether features for the second application are currently running; if the features for the second application are not currently running, to create a second virtual machine having the second platform, and the rights and policies for the second application; and to provide an instance of the second application on the second virtual machine.

4. The information handling system of claim 1 wherein the rights and policies are selected from a group selected from an approval process for a purchase of a particular instance of an application, and what can be allowable targets.

5. The information handling system of claim 4 wherein the allowable targets are selected based on whether an application can be run on a public cloud, or constrained to a private cloud.

6. The information handling system of claim 1 wherein the features can include a web server, an application server, data access, and a specific platform of the plurality of platforms.

7. A method comprising:
receiving, at a server, a first application associated with a first platform of a plurality of platforms, and a second application associated with a second platform of the plurality of platforms;
receiving rights and policies for the first application, and rights and policies for the second application;
including the rights and policies for the first application as metadata in the first application, and the rights and policies for the second application as metadata in the second application;
receiving a selection of the first application;
determining, by the server, whether features for the first application are currently running;
if the features for the first application are not currently running, creating a first virtual machine having the first platform, and the rights and policies for the first application; and
providing an instance of the first application on the first virtual machine.

8. The method of claim 7 further comprising:
receiving a selection of a second application;
determining whether features for the second application are currently running;
if the features for the second application are not currently running, creating a second virtual machine having the second platform, and the rights and policies for the second application; and
providing an instance of the second application on the second virtual machine.

9. The method of claim 7 wherein the rights and policies are selected from a group selected from an approval process for a purchase of a particular instance of an application, and what can be allowable targets.

10. The method of claim 9 wherein the allowable targets are selected based on whether an application can be run on a public cloud, or constrained to a private cloud.

11. The method of claim 7 wherein the features can include a web server, an application server, data access, and a specific platform of the plurality of platforms.

12. The method of claim 7 wherein the first virtual machine and the second virtual machine are partitions of a server.

13. A computer readable medium comprising a plurality of instructions to manipulate a processor, the plurality of instructions comprising:
instructions to receive a first application associated with a first platform of a plurality of platforms, and a second application associated with a second platform of the plurality of platforms;
instructions to receive rights and policies for the first application, and rights and policies for the second application;
instructions to include the rights and policies for the first application as metadata in the first application, and the rights and policies for the second application as metadata in the second application;
instructions to receive a selection of the first application;
instructions to determine whether features for the first application are currently running;
if the features for the first application are not currently running, instructions to create a first virtual machine having the first platform, and the rights and policies for the first application; and
instructions to provide an instance of the first application on the first virtual machine.

14. The computer readable medium of claim 13 further including:
instructions to receive a selection of a second application;
instructions to determine whether features for the second application are currently running;
if the features for the second application are not currently running, instructions to create a second virtual machine having the second platform, and the rights and policies for the second application; and
instructions to provide an instance of the second application on the second virtual machine.

15. The computer readable medium of claim 13 wherein the rights and policies are selected from a group selected from an approval process for a purchase of a particular instance of an application, and what can be allowable targets.

16. The computer readable medium of claim 15 wherein the allowable targets are selected based on whether an application can be run on a public cloud, or constrained to a private cloud.

17. The computer readable medium of claim 13 wherein the features can include a web server, an application server, data access, and a specific platform of the plurality of platforms.

18. The computer readable medium of claim 13 wherein the first virtual machine and the second virtual machine are partitions of a server.
